(19) United States
(12) Patent Application Publication
(10) Pub. No.: US 2024/0168655 A1
(43) Pub. Date: May 23, 2024

(54) SYSTEMS, DEVICES, AND METHODS FOR MICRO-SEGMENTATION AS A SERVICE

(71) Applicant: SAUDI ARABIAN OIL COMPANY, Dhahran (SA)

(72) Inventors: Ahmed S. AL SHAKH, Adu duf (SA); Khaled A. AL HUMAID, Dhahran (SA)

(73) Assignee: SAUDI ARABIAN OIL COMPANY, Dhahran (SA)

(21) Appl. No.: 18/056,459

(22) Filed: Nov. 17, 2022

(51) Int. Cl. G06F 3/06

(52) U.S. Cl. CPC G06F 3/0622; G06F 3/0655; G06F 3/0673

(57) ABSTRACT

According to some embodiments, micro-segmentation as a service (MSaaS) tools for managing a micro-segmentation lifecycle include a storage device for storing one or more micro-segmentation policies, micro-segmentation metadata associated with one or more distributed firewall systems, or a combination thereof, and an MSaaS engine. The MSaaS engine is configured to receive a request for a micro-segmentation service, determine whether a micro-segmentation policy of the one or more micro-segmentation policies permits the micro-segmentation service, and in response to a determination that the micro-segmentation policy permits the micro-segmentation service, update the micro-segmentation metadata with data identified by the micro-segmentation service.

### FIELD OF THE DISCLOSURE

The present description relates generally to ensuring the security and protection of system components communicating via networks and, more particularly, to systems, devices and methods for providing micro-segmentation as a service for distributed firewall systems.

### BACKGROUND OF THE DISCLOSURE

Compute resources, as used herein, collectively refers to the computer systems, to include both physical and virtual components, of an organization. The compute resources may include multiple computer systems communicating via one or more networks that enable sharing of the compute resources. An organization may use multiple networks to secure and protect compute resources. The multiple networks may be configured to optimize sharing of the compute resources to distributed users of the organization. One or more of the multiple networks may be configured as a network local to a particular location, while other networks of the multiple networks may be configured to utilize one or more remote compute resources, such as compute resources in the cloud. Optimizing sharing of the compute resources results in different configurations that may include one or more of physical host systems, virtual machines, containers, load balancers, or a combination thereof. An organization may use one or more firewall systems to ensure the security and protection of the compute resources communicating via the multiple networks. A firewall system may include one or more physical devices, one or more computer applications, one or more sets of firewall rules governing communications via one or more networks protected by the firewall system, or a combination thereof, and may be referred to as a distributed firewall system.

To provide security and protection for the compute resources of an organization, one or more of the compute resources may be segmented into a logical grouping based on rules, or assertions, determined using organizational criteria. A distributed firewall system may then be configured to provide a firewall for the logical grouping. The complexity of the task associated with defining logical groupings and assigning one or more sets of firewall rules to the logical groupings within the organization varies depending upon organization-dependent factors, such as the size of the organization, the number of levels of security within the organization, the number of networks of the organization, and the number of owners associated with one or more compute resources.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the purpose of this summary is to present some concepts of the disclosure in a simplified form prior to the more detailed description that is presented hereinafter.

According to an embodiment of the present disclosure, a micro-segmentation as a service (MSaaS) tool for managing a micro-segmentation lifecycle includes a storage device for storing one or more micro-segmentation policies, micro-segmentation metadata associated with one or more distributed firewall systems, or a combination thereof, and an MSaaS engine. The MSaaS engine is configured to receive a request for a micro-segmentation service, determine whether a micro-segmentation policy of the one or more micro-segmentation policies permits the micro-segmentation service, and in response to a determination that the micro-segmentation policy permits the micro-segmentation request, update the micro-segmentation metadata with data identified by the micro-segmentation service.

In another embodiment of the present disclosure, a method for managing a micro-segmentation lifecycle includes receiving a request for a micro-segmentation service, determining whether a micro-segmentation policy of the one or more micro-segmentation policies permits the micro-segmentation service, and in response to a determination that the micro-segmentation policy permits the micro-segmentation request, updating the micro-segmentation metadata with data identified by the micro-segmentation service.

In another embodiment of the present disclosure, a non-transitory computer-readable medium (CRM) stores computer-executable instructions, which, when executed by a processor, cause the processor to receive a request for a micro-segmentation service, determine whether a micro-segmentation policy of the one or more micro-segmentation policies permits the micro-segmentation service, and in response to a determination that the micro-segmentation policy permits the micro-segmentation request, update micro-segmentation metadata stored to a storage device with data identified by the micro-segmentation service.

Any combinations of the various embodiments and implementations described herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a system including a micro-segmentation as a service (MSaaS) tool, in accordance with certain embodiments.

FIG. 2 is a block diagram of a system including compute resources managed by an MSaaS tool, in accordance with certain embodiments.

FIG. 3 is a flow diagram of a method for providing micro-segmentation as a service, in accordance with certain embodiments.

FIG. 4 is a block diagram of a computer system that can be employed to execute a system for providing micro-segmentation as a service, in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments described herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to ensuring the security and protection of compute resources of organizations and, more particularly, to systems, devices and methods for providing micro-segmentation as a service (MSaaS) for distributed firewall systems. According to various embodiments, an MSaaS tool manages a micro-segmentation lifecycle that includes multiple firewall rules used in operations of one or more distributed firewall systems. A micro-segmentation lifecycle, as used herein, includes receiving a request to segment one or more compute resources, determining whether to approve the request, implementing the segment based on the request, periodically recertifying the segment, decommissioning one or more segments, and troubleshooting one or more segments. By automating management of the micro-segmentation lifecycle, the MSaaS tool enhances a responsiveness of distributed firewall systems of the organization to changes within the compute resources by reducing an amount of time accrued while waiting on one or more owners of compute resources associated with a request to determine or modify firewall rules associated with the compute resources, and reduces the need to dedicate large amounts of human administrator time and effort to establish and manage security and firewall protections. Enhancing the responsiveness of distributed firewall systems increases a responsiveness of the distributed firewall systems to evolving security threats. Supporting one or more distributed firewall systems using the MSaaS tool enhances an effectiveness of propagating changes consistently across an organization, regardless of network location and location of compute resources. Additionally, the MSaaS tool enhances a responsiveness of the distributed firewall systems of the organization by preventing human errors that may occur during manual configurations.

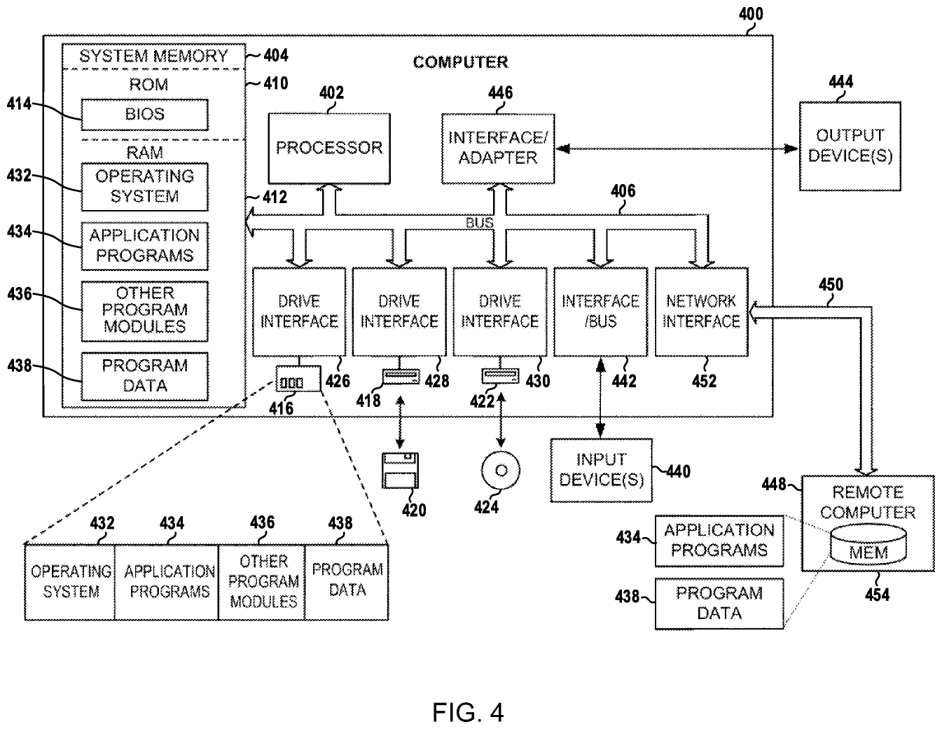

As described above, an organization may use multiple networks to provide compute resources to both local and remote users. The multiple networks may be configured to optimize sharing of the compute resources to the users, resulting in different configurations that may include one or more of physical host systems, virtual machines, containers, load balancers, or a combination thereof. A physical host system, as used herein, includes one or more physical devices, such as computer systems and storage devices described below with respect to FIG. 4, that support the abstraction and pooling of compute resources to provide one or more virtual machines, containers, or load balancers. A virtual machine, as used herein, is an isolated operating environment that includes virtual resources pooled from one or more physical host systems, such as processing, memory, storage, or network resources, and is capable of executing an operating system and one or more computer applications. A container, as used herein, is an isolated operating environment within a virtual machine or a physical host machine that includes virtual resources pooled from one or more physical host systems such as processing, memory, storage, or network resources, and is capable of executing one or more computer applications. A load balancer, as used herein, is hardware, software, or a combination thereof that distributes network traffic across multiple servers.

To ensure that security breaches, if they occur, within one environment do not affect other environments within the multiple networks of an organization, the MSaaS tool segments one or more of the compute resources into a logical grouping, or segment, based on rules, or assertions, determined using organizational criteria specified in a micro-segmentation policy. Non-limiting examples of environments include one or more compute resources that are associated with an Internet Protocol (IP) network segment (e.g., 10.0.0.0/8), one or more compute resources having a same role within a configuration management system (e.g., “Production,” “R&D”, “HR,” “Manufacturing”), or a combination thereof. A compute resource, as used herein, may include hardware components, software components, or a combination thereof, for performing specified operations of an organization. Non-limiting examples of a compute resource include, a computer system, a network system, one or more components of the computer system, one or more components of the network system, or a combination thereof, as described below with respect to FIG. 4. A micro-segmentation policy, as used herein, includes one or more assertions that maintain a security of an environment associated with the micro-segmentation policy. One or more firewall rules may then be applied to the segment. A firewall rule, as used herein, determines whether a network packet may be communicated along a specified network path. A network path, as used herein, describes a route a network packet traverses between an originating compute resource, or source, of the network packet and a specified end destination compute resource, or destination. The MSaaS tool may store metadata associated with the segment to a database used in operations of one or more distributed firewall systems. Non-limiting examples of data of the metadata include one or more of an environment identifier, a security zone identifier, a security group identifier, a shared service identifier, a source identifier, a destination identifier, one or more compute resource identifiers, a network service identifier, or other identifiers used in routing network packets.

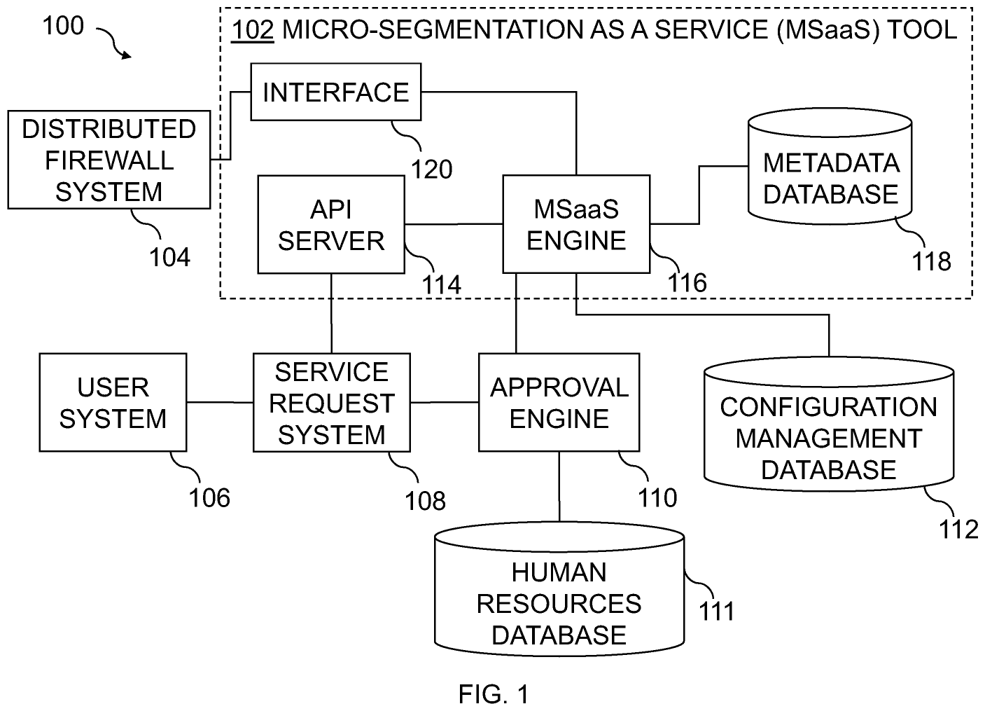

FIG. 1 is a block diagram of a system 100 including an MSaaS tool 102, in accordance with certain embodiments. In a non-limiting example, the system 100 includes the MSaaS tool 102 for providing micro-segmentation as a service for managing a micro-segmentation lifecycle. The system 100 is a portion of one or more networks used by an organization, for example. In a non-limiting example, the system 100 includes one or more systems, as described below with respect to FIG. 1, that communicate via a combination of local and remote networks, such as in a distributed system that is hosted, completely or in part, in the cloud. Using data from sources such as a user system 106, a service request system 108, an approval engine 110, a configuration management database 112, and the like, the MSaaS tool 102 can determine whether a request for a micro-segmentation service is permitted by a micro-segmentation policy, and in response to a determination that the micro-segmentation policy permits the micro-segmentation service, update micro-segmentation metadata with data identified by the micro-segmentation service. In non-limiting examples the micro-segmentation service includes one or more of a request to create or delete an environment, a request to create, modify, or delete a security group, a request to create, modify, delete, deactivate, or activate a security zone, a request to create, modify, or delete a shared service, a request to create, modify, delete, deactivate, activate, or recertify a firewall rule, or a request to provide a report. A shared service, as used herein, indicates that compute resources identified as shared services should either be accessible by all other compute resources of the organization (e.g., Domain Name System (DNS) servers) or have access to all other compute resources of the organization (e.g., security scanners)

In various non-limiting examples, the request for the micro-segmentation service is retrieved by the MSaaS tool 102 from a computer-readable media, such as described below with respect to FIG. 4. In other non-limiting examples, the request for the micro-segmentation service is received by the MSaaS tool 102 via an input device or via a network interface, as described below with respect to FIG. 4. In various embodiments, an output of the MSaaS tool 102 is stored to a computer-readable media, such as metadata database 118, which stores the metadata of segments associated with an organization.

In some non-limiting examples, the request for the micro-segmentation service is received by the MSaaS tool 102 from the user system 106 via the service request system 108. The user system 106 and the service request system may be a system as described below with respect to FIG. 4, for example. In a non-limiting example, a user of the user system 106 submits the request for the micro-segmentation service to the service request system 108. The user system 106 may submit the request via a browser of a computer application installed to the user system 106, for example. In another non-limiting example, the service request system 108 is a web application accessible by the browser of the user system 106.

In various non-limiting examples, the service request system 108 verifies that the user has permission to request the micro-segmentation service by transmitting a query to the approval engine 110. In some non-limiting examples, the approval engine 110 retrieves a role of the user from a human resources (HR) database 111, or other database storing user access permissions, roles, or a combination thereof, to determine whether the role indicates that the user has permission to request the micro-segmentation service. The HR database 111 or other database is a computer-readable media, such as described below with respect to FIG. 4. In some non-limiting examples, in response to an indication from the approval engine 110 that the user has permission to request the micro-segmentation service, the service request system 108 may transmit the request for the micro-segmentation service to the MSaaS tool 102. In other non-limiting examples, in response to an indication from the approval engine 110 that the user has permission to request the micro-segmentation service, the service request system 108 may store the request for the micro-segmentation service to a computer-readable media, such as described below with respect to FIG. 4, for later transmission to the MSaaS tool 102. The later transmission may be at specified time intervals or in response to a request from the MSaaS tool 102, for example.

Within the MSaaS tool 102, in a non-limiting example, an application programming interface server 114, or API server 114, receives the request for the micro-segmentation service, and an MSaaS engine 116 processes the request. In non-limiting examples, the MSaaS engine 116 determines whether a micro-segmentation policy of the organization permits the micro-segmentation service, and in response to a determination that the micro-segmentation policy permits the micro-segmentation service, the MSaaS engine 116 updates the metadata database 118 with data identified by the micro-segmentation service. In some non-limiting examples, in response to a determination that the micro-segmentation policy permits the micro-segmentation service, the MSaaS engine 116 propagates the data identified by the micro-segmentation service to one or more distributed firewall systems 104 via an interface 120. In various non-limiting examples, in response to a determination that the micro-segmentation policy permits the micro-segmentation service, the MSaaS engine 116 updates the configuration management database 112 to reflect one or more modifications requested by the micro-segmentation service to the organization's hardware components, software components, to the relationships between the hardware components, the software components, or to a combination thereof. In other non-limiting examples, in response to the micro-segmentation service including a request to provide a report, the MSaaS engine 116 generates a firewall denied report, a simulated network traffic report, an owner report, or a combination thereof, and causes transmission of the report to the user system 106.

As described above, a micro-segmentation policy includes one or more assertions that maintain a security of an environment associated with the micro-segmentation policy. An organization's networks may include multiple environments, and each environment may have a micro-segmentation policy. In a non-limiting example, the one or more assertions that maintain the security of the environment include that a security zone and one or more compute resources associated with the security zone are to be owned by a same owner, that a security group and one or more compute resources associated with the security group are to be owned by the same owner, that a compute resource is to be associated with a single security zone, that a firewall rule is to be associated with at least one of a security zone or a zoned security group, that a security zone is to be associated with a single environment, and that a security group is to be associated with a single security zone or no security zone. An organization may include one or more environments. A zero-trust environment, as used herein, is an environment in which communication between compute resources inside the zero-trust environment and communications between compute resources outside the zero-trust environment and inside the zero-trust environment are denied by default. An environment in which communication between the compute resources are permitted by default is herein referred to as standard environment. In various non-limiting examples, an organization may specify other types of environments and generate micro-segmentation policies for use with the specified environment. A security zone, as used herein, is a segmentation of compute resources in which communications between the compute resources within the security zone is permitted by default. Establishing a security zone is referred to as creating an east/west micro-segmentation. A security group, as used herein, is a source or a destination, as specified by a firewall rule. A compute resource within a security zone may herein be referred to as a zoned compute resource while a compute resource not within a security zone may herein be referred to as an unzoned compute resource. An owner of a compute source, as used herein, may refer to one or more users who have permission to access the compute source. A role of a user may indicate whether the user is an owner of the compute resource, in a non-limiting example.

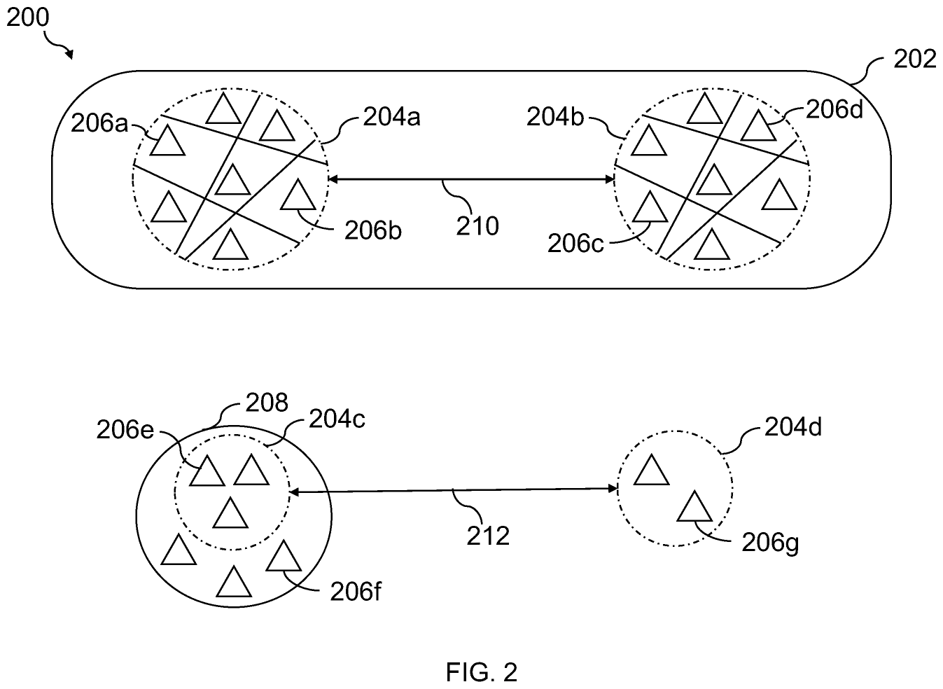

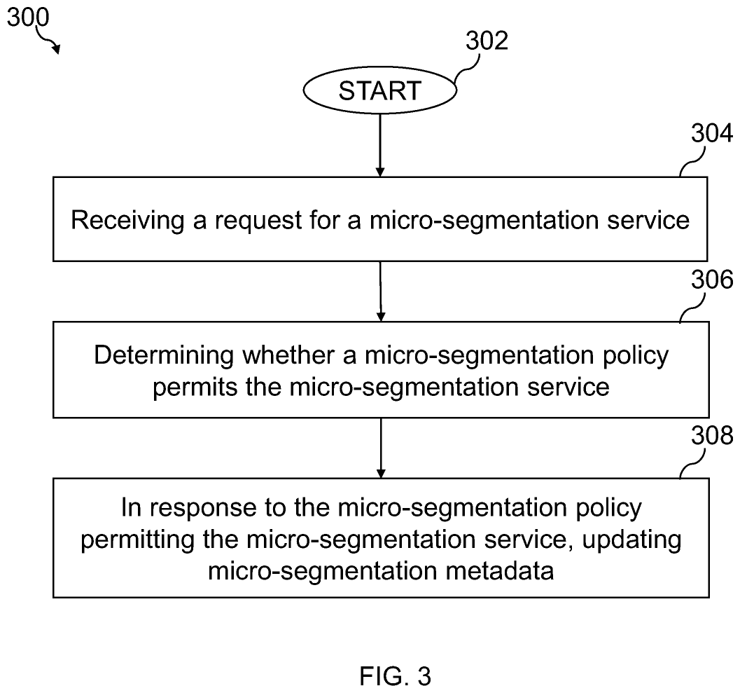

FIG. 2 is a block diagram of a system 200 including compute resources 206a, 206b, 206c, 206d, 206e, 206f, 206g managed by an MSaaS tool, in accordance with certain embodiments. In non-limiting examples, the MSaaS tool is the MSaaS tool described with respect to FIG. 1 or 3. In non-limiting examples, the system 200 includes one or more components of the system 100. In non-limiting examples, the compute resources 206a, 206b, 206c, 206d, 206e, 206f, 206g include physical host systems, virtual machines, containers, load balancers, or other physical or virtual system components of an organization. In non-limiting examples, the physical or virtual system components may be one or more components shown below with respect to FIG. 4 or hosted on one or more components shown below with respect to FIG. 4, respectively. The compute resources 206a, 206b, 206c, 206d, 206e, 206f, 206g are herein collectively referred to as compute resources 206. The system 200 includes a zero-trust environment 202, security groups 204a, 204b, 204c, and a security zone 208. The security groups 204a, 204b, 204c are herein collectively referred to as security groups 204.

In a non-limiting example, the MSaaS tool receives a request for a micro-segmentation service that includes a request to create the zero-trust environment 202. In response to verifying that the micro-segmentation service is permitted by a micro-segmentation policy for the system 200, the MSaaS tool creates the zero-trust environment 202. Creating the zero-trust environment 202 may include updating a configuration management database associated with the system 200, updating a metadata database to include data associated with the zero-trust environment 202, updating a distributed firewall system associated with the system 200, or a combination thereof. The data may include identifiers associated with the compute resources (e.g., the compute resources 206a, 206b, 206c, 206d) within the zero-trust environment 202, a firewall rule that denies communications between and with the compute resources within the zero-trust environment 202. The MSaaS tool may update the configuration database to indicate that the zero-trust environment 202 includes the compute resources 206a, 206b, 206c, 206d, for example.

In the non-limiting example, the MSaaS tool receives a request for a micro-segmentation service that includes a request to create a firewall rule that enables communications between security groups 204a and 204b along a path 210. In response to verifying that the micro-segmentation service is permitted by a micro-segmentation policy for the system 200, the MSaaS tool creates the firewall rule that enable communications between the security groups 204a and 204b via the path 210. Creating the firewall rule may include updating the configuration management database associated with the system 200, updating the metadata database to include data associated with the firewall, updating a distributed firewall system associated with the system 200, or a combination thereof. For example, the MSaaS tool may associate the firewall rule with the zero-trust environment 202 in the metadata database as a second firewall rule of the zero-trust environment 202 and store the security group 204a as a source and the security group 204b as a destination, may update the configuration database to indicate that the security group 204a includes the compute resources 206a, 206b and that the security group 204b includes the compute resources 206c, 206d, or a combination thereof.

In the non-limiting example, the MSaaS tool receives a request for a micro-segmentation service that includes a request to create a firewall rule that enables communications between security groups 204c and 204d along a path 212. In response to verifying that the micro-segmentation service is permitted by a micro-segmentation policy for the system 200, the MSaaS tool creates the firewall rule that enable communications between the security groups 204c and 204d via the path 212. Creating the firewall rule may include updating the configuration management database associated with the system 200, updating the metadata database to include data associated with the firewall, updating a distributed firewall system associated with the system 200, or a combination thereof. For example, the MSaaS tool may associate the firewall rule with the system 200 in the metadata database and store the security group 204c as a source and the security group 204d as a destination, may update the configuration database to indicate that the security group 204c includes the compute resources 206e and that the security group 204d includes the compute resource 206g, or a combination thereof.

In the non-limiting example, the MSaaS tool receives a request for a micro-segmentation service that includes a request to create the security zone 208. In response to verifying that the micro-segmentation service is permitted by a micro-segmentation policy for the system 200, the MSaaS tool creates the security zone 208. Creating the security zone may include updating the configuration management database associated with the system 200, updating the metadata database to include data associated with the security zone 208, updating a distributed firewall system associated with the system 200, or a combination thereof. The data may include identifiers associated with the compute resources (e.g., the compute resources 206e, 2060 and the security group 204c within the security zone 208, a first firewall rule that denies communications by default with compute resources (e.g., the compute resources 206a, 206b, 206c, 206d) outside the security zone 208, a second firewall rule that permits communications between compute resources (e.g. the compute resources 206e, 2060 within the security zone 208 by default, and associating the firewall rule that enables communications between the security groups 204c and 204d along the path 212. The MSaaS tool may update the configuration database to indicate that the security zone 208 includes the compute resources 206e, 206f and the security group 204c.

FIG. 3 is a flow diagram of a method 300 for providing micro-segmentation as a service, in accordance with certain embodiments. In a non-limiting example, the method 300 is used by an MSaaS tool for managing a micro-segmentation lifecycle of an organization. The method 300 is used by an MSaaS tool as described with respect to FIG. 1 or 2, for example. The method 300 includes starting (block 302), receiving a request for a micro-segmentation service (block 304), determining whether a micro-segmentation policy permits the micro-segmentation service (block 306), and in response to the micro-segmentation policy permitting the micro-segmentation service, updating micro-segmentation metadata (block 308).

Starting block 302 includes, but is not limited to, receiving an input from a user, the present system, another system, or a combination thereof, that indicates the present system is to perform the method 300. Receiving the request for the micro-segmentation service at block 304 includes, but is not limited to receiving the request from one or more computer-readable medium, input devices, network interfaces, or a combination thereof, associated with the present system, another system, or a combination thereof. In a non-limiting example, receiving the request for the micro-segmentation service at block 304 includes determining an action requested by the micro-segmentation service, and generating an indicator that indicates the action. In non-limiting examples, an output of the block 304 includes an indicator based on whether the micro-segmentation request includes one or more of creating or deleting an environment, creating, modifying, or deleting a security group, creating, modifying, deleting, deactivating, or activating a security zone, creating, modifying, or deleting a shared service, creating, modifying, deleting, deactivating, activating, or recertifying a firewall rule, performing troubleshooting. For example, the method 300 may include comparing the action requested to a database including the different types and combinations of services possible and retrieving an indicator associated with an identified match with one of the different types and combinations of services.

In a non-limiting example, determining whether a micro-segmentation policy permits the micro-segmentation service at block 306 includes identifying one or more environments, security zones, security groups, compute resources, firewall rules, shared services or a combination thereof, associated with the micro-segmentation service. In another non-limiting example, determining whether a micro-segmentation policy permits the micro-segmentation service at block 306 includes comparing the identifying information to one or more of metadata stored to a storage device, configuration data stored to a storage device, or a combination thereof.

In some non-limiting examples, the method 300 further includes, in response to the determination that the micro-segmentation policy permits the micro-segmentation service at block 306, verifying an approval of the micro-segmentation service with an approval engine, in response to verifying the approval, verifying an ownership of the micro-segmentation service, and in response to verifying the ownership, performing the micro-segmentation service, where performing the micro-segmentation request includes updating the micro-segmentation metadata at block 308. In a non-limiting example, verifying an ownership includes comparing a user identifier or role to an owner of one or more compute resources impacted by the micro-segmentation service. In a non-limiting example, updating the micro-segmentation metadata at block 308 includes storing the metadata to a storage device, updating data of a configuration management database, propagating the metadata to one or more distributed firewall systems, or a combination thereof.

In other non-limiting examples in which the micro-segmentation service includes creating a firewall rule, the method 300 further includes setting a source for a network path, setting a destination for the network path, setting one or more network services for the network path, and setting an expiry date for the firewall rule. In a non-limiting example, the method 300 includes storing the source, destination, one or more network services, and expiry date to the micro-segmentation metadata. The source for the network path may be a security zone, a security group, a shared service, or a compute resource, for example. The destination for the network path may be a security group, a security zone, a compute resource, or a shared service, for example. In some non-limiting examples in which the micro-segmentation service includes creating, modifying, deleting, deactivating, activating, recertifying, or a combination thereof, a firewall rule, the method 300 includes asserting approval and asserting ownership prior to creating, modifying, deleting, deactivating, activating, recertifying, or a combination thereof, the firewall rule.

In some non-limiting examples in which the micro-segmentation service includes recertifying the firewall rule, the method 300 further includes retrieving an expiry date for the firewall rule, determining whether one or more additional firewall rules having expiry dates within a specified time period of the expiry date for the firewall rule share an owner as the firewall rule for recertifying, extending the expiry date (e.g., setting a new expiry date) for one or more of the firewall rule or the one or more additional firewall rules having expiry dates within the specified period, and generating a notification to the owner regarding the extension. The notification may include sending information regarding the firewall rule, the one or more additional firewall rules, or a combination thereof, an escalation notice to one or more owners of an escalation path, or a combination thereof. In various non-limiting examples in which the micro-segmentation service includes recertifying the firewall rule, the method 300 further includes identifying one or more expired firewall rules and deactivating the one or more expired firewall rules. In various non-limiting examples in which the micro-segmentation service includes deleting the firewall rule, the method 300 further includes identifying one or more deactivated or expired firewall rules within a specified period and deleting the one or more deactivated or expired firewall rules.

In other non-limiting examples in which the micro-segmentation service includes deleting an environment, the method 300 further includes deleting one or more security groups, security zones, firewall rules, or combination thereof, associated with the environment prior to deleting the environment. In some non-limiting examples in which the micro-segmentation service includes deleting a security group, the method 300 further includes deleting one or more firewall rules associated with the security group prior to deleting the security group. In some non-limiting examples in which the micro-segmentation service includes deleting a security zone, the method 300 further includes deleting one or more firewall rules associated with the security zone prior to deleting the security zone. In some non-limiting examples in which the micro-segmentation service includes deleting a security group, the method 300 further includes deleting one or more firewall rules associated with the security group prior to deleting the security group. In some non-limiting examples in which the micro-segmentation service includes deleting a shared service, the method 300 further includes deleting one or more firewall rules associated with the shared service prior to deleting the shared service.

In some non-limiting examples in which the micro-segmentation service includes deactivating a security zone, the method 300 further includes deactivating all firewall rules associated with the security zone to include deactivating firewall rules denying communications to or from the security zone. In other non-limiting examples in which the micro-segmentation service includes activating a security zone, the method 300 further includes activating all firewall rules associated with the security zone to include activating firewall rules denying communications to or from the security zone.

In other non-limiting examples in which the micro-segmentation service includes troubleshooting, the method 300 further includes setting a source IP, setting a destination IP, and generating a firewall rule deny report. In some non-limiting examples in which the micro-segmentation service includes troubleshooting, the method 300 further includes setting a source IP, setting a destination IP, and generating a simulated network traffic report. In various non-limiting examples in which the micro-segmentation service includes troubleshooting, the method 300 further includes generating an owner report that includes security groups, security zones, firewall rules, shared services, environments, or a combination thereof owned by an owner.

The blocks of the method 300 may be executed by one or multiple computer applications. The blocks of the method 300 may be executed in any order, and in any combination, and may individually be executed one or more times. As a non-limiting example, block 304 may be executed six (6) times followed by three (3) executions of block 306, followed by executions of block 304 two (2) times then executions of block 308 two (2) times, block 306 seven (7) times, and block 308 eight (8) times.

System 100, system 200, and method 300 may each be partially or wholly implemented, in any combination, as part of an MSaaS tool or multiple MSaaS tools used by one or more organizations for ensuring security and protection of compute resources of the organization generally. While the examples described herein refer to a single organization, one skilled in the art will recognize that the MSaaS tool described herein may provide services to multiple organizations. In a non-limiting example, multiple user systems from multiple organizations may transmit requests for micro-segmentation services via multiple service request systems. The MSaaS tool may include multiple metadata databases, one or more for each organization of the multiple organizations. Processing a request for a micro-segmentation service may include identifying an organization associated with the request. The MSaaS tool may use the organization identifier to determine a relevant micro-segmentation policy to use in processing the request, a metadata database to use in processing the request, a configuration management database to use in processing the request, a distributed firewall system to use in processing the request, or a combination thereof.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 45 U.S.C. § 101 (such as a propagating electrical or electromagnetic signal per se). As an example and not by way of limitation, a computer-readable storage media may include a semiconductor-based circuit or device or other IC (such as, for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions specified in the flowchart block or blocks.

FIG. 4 is a block diagram of a computer system that can be employed to execute a system for analyzing ransomware threat intelligence in accordance with certain embodiments described. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 440, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 412, including operating system 432, one or more computer application programs 434, other program modules 436, and program data 438. In some examples, the computer application programs 434 can include one or more sets of computer-executable instructions of the MSaaS tool 102, one or more sets of computer-executable instructions of the user system 106, one or more sets of computer-executable instructions of the service request system 108, one or more sets of computer-executable instructions of the approval engine 110, and one or more sets of computer-executable instructions of the distributed firewall system 104, and the program data 438 can include the data stored to the metadata database 118 and the data stored to the configuration management database 112. The computer application programs 434 and program data 438 can include functions and methods programmed to perform the method 300 to provide micro-segmentation as a service for managing a lifecycle of micro-segmentation associated with providing security for one or more networks, such as shown and described herein.

A user may enter commands and information into computer system 400 through one or more input devices 440, such as a pointing device (e.g., a mouse, touch screen), keyboard, microphone, joystick, game pad, scanner, and the like. For instance, the user can employ input device 440 to edit or modify the MSaaS tool 102, the service request system 108, data stored to the databases 111, 112. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and a wide area network (WAN). When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, computer application programs 434 or program data 438 depicted relative to computer system 400, or portions thereof, may be stored in a remote memory storage device 454.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, blocks, operations, elements, and/or components, but do not preclude the presence or addition of one or more other features, integers, blocks, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the description has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the description without departing from the essential scope thereof. Therefore, it is intended that the invention not be limited to the particular embodiments described, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A micro-segmentation as a service (MSaaS) tool for managing a micro-segmentation lifecycle, comprising:
a storage device for storing one or more micro-segmentation policies, micro-segmentation metadata associated with one or more distributed firewall systems, or a combination thereof; and
an MSaaS engine configured to:
receive a request for a micro-segmentation service;
determine whether a micro-segmentation policy of the one or more micro-segmentation policies permits the micro-segmentation service; and
in response to a determination that the micro-segmentation policy permits the micro-segmentation service, update the micro-segmentation metadata with data identified by the micro-segmentation service.

2. The MSaaS tool of claim 1, wherein the micro-segmentation policy of the one or more micro-segmentation policies includes one or more assertions that maintain a security of an environment associated with the micro-segmentation policy.

3. The MSaaS tool of claim 2, wherein the one or more assertions that maintain the security of the environment includes a security zone and one or more compute resources associated with the security zone are to be owned by a same owner, a security group and one or more compute resources associated with the security group are to be owned by the same owner, a compute resource is to be associated with a single security zone, a firewall rule is to be associated with at least one of a security zone or a zoned security group, a security zone is to be associated with a single environment, and a security group is to be associated with a single security zone or no security zone.

4. The MSaaS tool of claim 1, wherein the micro-segmentation service includes one or more of a request to create or delete an environment, a request to create, modify, or delete a security group, a request to create, modify, delete, deactivate, or activate a security zone, a request to create, modify, or delete a shared service, a request to create, modify, delete, deactivate, activate, or recertify a firewall rule, or a request to provide a report.

5. The MSaaS tool of claim 4, wherein the report includes a firewall rule denied report, a simulated network traffic report, an owner report detailing one or more security groups, security zones, firewall rules, shared services, or a combination thereof, associated with an owner, or a combination thereof.

6. A method comprising:
receiving a request for a micro-segmentation service;
determining whether a micro-segmentation policy of the one or more micro-segmentation policies permits the micro-segmentation service; and
in response to a determination that the micro-segmentation policy permits the micro-segmentation service, updating a micro-segmentation metadata with data identified by the micro-segmentation service.

7. The method of claim 6, further comprising:
in response to the determination that the micro-segmentation policy permits the micro-segmentation service, verifying an approval of the micro-segmentation service with an approval engine;
in response to verifying the approval, verifying an ownership of the micro-segmentation service; and
in response to verifying the ownership, perform the micro-segmentation service, wherein performing the micro-segmentation service includes updating the micro-segmentation metadata.

8. The method of claim 7, wherein performing the micro-segmentation service, further comprises one or more of creating or deleting an environment, creating, modifying, or deleting a security group, creating, modifying, deleting, deactivating, or activating a security zone, creating, modifying, or deleting a shared service, creating, modifying, deleting, deactivating, activating, or recertifying a firewall rule, performing troubleshooting.

9. The method of claim 8, wherein creating the firewall rule, further comprises:
setting a source for a network path;
setting a destination for the network path;
setting one or more network services for the network path; and
setting an expiry date for the firewall rule.

10. The method of claim 8, wherein recertifying the firewall rule further comprises:
retrieving an expiry date for the firewall rule;
determining whether one or more additional firewall rules having expiry dates within a specified time period of the expiry date for the firewall rule share an owner as the firewall rule for recertifying;
extending the expiry date for one or more of the firewall rule or the one or more additional firewall rules having expiry dates within the specified period; and
generating a notification to the owner regarding the extension.

11. A non-transitory computer-readable medium storing computer-executable instructions, which, when executed by a processor, cause the processor to:
receive a request for a micro-segmentation service;
determine whether a micro-segmentation policy of the one or more micro-segmentation policies permits the micro-segmentation service; and
in response to a determination that the micro-segmentation policy permits the micro-segmentation request, update micro-segmentation metadata stored to a storage device with data identified by the micro-segmentation service.

12. The non-transitory computer-readable medium of claim 11, wherein the processor is operable to:
in response to the determination that the micro-segmentation policy permits the micro-segmentation request, verify an approval of the micro-segmentation request with an approval engine;
in response to verifying the approval, verify an ownership of the micro-segmentation request; and
in response to verifying the ownership, perform the micro-segmentation request, wherein performing the micro-segmentation request includes updating the micro-segmentation metadata.

13. The non-transitory computer-readable medium of claim 12, wherein to perform the micro-segmentation request, the processor is operable to:
create or delete an environment;
create, modify, or delete a security group;
create, modify, delete, deactivate, or activate a security zone;
create, modify, or delete a shared service;
create, modify, delete, deactivate, activate, or recertify a firewall rule; and
perform troubleshooting.

14. The non-transitory computer-readable medium of claim 13, wherein to create the firewall rule, the processor is operable to:
store, to the storage device, a source for a network path;
store, to the storage device, a destination for the network path;
store, to the storage device, one or more network services for the network path; and
store, to the storage device, an expiry date for the firewall rule.

15. The non-transitory computer-readable medium of claim 11, wherein to recertify the firewall rule, the processor is operable to:
retrieve, from the storage device, an expiry date for the firewall rule;
determine whether one or more additional firewall rules having expiry dates within a specified time period of the expiry date for the firewall rule share an owner as the firewall rule for recertifying;
store a new expiry date for one or more of the firewall rule or the one or more additional firewall rules having expiry dates within the specified period to the storage device; and
generate a notification to the owner regarding the extension.
